(19) United States
(12) Patent Application Publication
(10) Pub. No.: US 2024/0149191 A1
(43) Pub. Date: May 9, 2024

(54) Method for Forming a Filter Medium

(71) Applicant: HYDAC Filtertechnik GmbH, Sulzbach / Saar (DE)

(72) Inventors: Michael Sakraschinsky, St. Ingbert (DE); Harald Mees, Lebach (DE)

(73) Assignee: HYDAC Filtertechnik GmbH, Sulzbach / Saar (DE)

(21) Appl. No.: 18/548,921

(22) PCT Filed: Feb. 25, 2022
(86) PCT No.: PCT/EP2022/054789

§ 371 Date: Sep. 4, 2023

(30) Foreign Application Priority Data
Mar. 5, 2021 (DE) 10 2021 001 192.9

(51) Int. Cl. B01D 29/11; B01D 29/21

(52) U.S. Cl. CPC B01D 29/111; B01D 29/21; B01D 2201/0415; B01D 2201/291; B01D 2201/347

(57) ABSTRACT

The invention relates to a method for forming a filter medium, which is suitable for filtering fluids, for a filter element, said method having at least the following steps: —applying at least one self-contained sealant (16, 28) onto a fluid-permeable media web (14) in a specifiable direction (26), —producing a solid composite at least between parts of the sealant (16, 28) and the media web (14), —pleating the composite, thereby forming individual filter folds, —producing a hollow body such that in order to —obtain at least one seal region on the media web (14), the respective sealant (16, 28) is arranged on the inner face of the hollow body, a seal is produced for each filter fold, and an end-face seal of the media web (14) is produced. An application medium is applied as the sealant (16, 28) onto the media web (14) in a strip-shaped manner along at least one longitudinal edge (51) of the media web (14), said sealant forming the respective seal region when cured.

### CROSS-REFERENCE TO RELATED APPLICATIONS

This application claims priority to German Patent Application No. DE 10 2021 001 192.9, filed on Mar. 5, 2021 with the German Patent and Trademark Office. The contents of the aforesaid patent application are incorporated herein for all purposes.

### TECHNICAL FIELD

The invention relates to a method for forming a filter medium, which is suitable for filtering fluids, for a filter element.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

DE 199 10 821 C2 discloses a method for producing a filter element which is provided in particular for installation in a tank housing of a hydraulic system and has a tubular filter mat as the media web, said filter mat enclosing an inner cavity for unfiltered liquid, said cavity being closed off at a bottom end by a lower end cap, which is connected to the adjacent rim of an outer supporting tube surrounding the filter mat, said tube being provided in certain regions with openings and being joined at the top upper end to an upper end cap, which has a throughflow opening for liquid to be filtered, the method including the following steps:
a) Flanging the bottom rim of the supporting tube inwards,
b) Inserting the lower end cap with a rim-side, recessed annular surface surrounding a central raised base part into the flanged bottom rim of the supporting tube,
c) Pouring an adhesive into the adhesive bath region defined by the rim-side annular surface of the lower end cap,
d) Sliding the filter mat into the supporting tube to form a bond at the lower end cap,
e) Providing such an upper end cap, the central throughflow opening of which is surrounded by a recessed, rim-side annular surface which defines an upper adhesive bath region and extends radially outwards on the supporting tube beyond the top rim thereof, on which a flange-like, radial extension is formed, providing a retaining surface for supporting the filter element on the rim of an opening of the tank housing,
f) Filling the adhesive bath region of the upper end cap with adhesive and
g) Inserting the top end of the filter mat surrounded by the supporting tube into the adhesive bath region of the upper end cap to form a top bond.

The known solution does not require prefabrication of an inner filter unit, so that the inner supporting tube can be omitted. However, the known method requires the production of adhesive bonds between the end caps and the intermediate filter medium in the form of the pleated media web, which involves increased effort in production terms.

WO 2011/060949 A2 discloses a method for forming a filter mat, which is suitable for filtering fluids, from at least one web portion of a mat web, at least one weld line sealing together the layers of at least one web portion of the mat web being formed and subsequently at least one incision being made along the at least one weld line in such a manner that the at least one web portion is cut through to form at least one sealed edge region. In this known solution, part of the weld line remains on the lateral edge(s) of the mat web and thus forms an edge seal due to which the ends of all layers are sealed by means of the welding operation melting the plastics material of the layers. In this way, any unwanted threading or fiber migration at the edges of the fluid-permeable media web is prevented.

### SUMMARY

A need exists to provide a method for producing a filter medium for a filter element which can be carried out in a simple and cost-effective manner.

The need is addressed by the subject matter of the independent claims. Embodiments of the invention are described in the dependent claims, the following description, and the drawings.

### BRIEF DESCRIPTION OF THE DRAWINGS

FIG. 1 to 3 show example main production steps in the form of a flow chart;

FIGS. 4 and 5 show partial details of an example pleated filter mat web with the sealant folded in, in one case in a top view, and in the other case in a view along the cutting line X-X in FIG. 4;

FIGS. 6 and 7 and 11 to 15 show various embodiments of filter elements in the form of a longitudinal section;

FIGS. 8, 9, 16 and 17 show various embodiments of filter devices; and

FIG. 10 shows an embodiment of a filter medium as a hollow body in the form of a longitudinal section.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for forming a filter medium is to be carried out with at least the following process steps:
Applying at least one self-contained sealant onto a fluid-permeable media web in a specifiable direction,
Producing a solid composite at least between parts of the sealant and the media web,
Pleating the composite to form individual filter pleats,
Producing a hollow body in that the two lateral edges of the media web, adjoining each other, opposite each other and extending transverse to the specifiable direction, are joined together such that in order to
Obtaining at least one sealing region on the media web, the respective sealant is arranged on the inner face of the hollow body, a seal is produced for each filter pleat, and an end-face seal of the media web is produced, an application medium being applied as sealant onto the media web in a strip-shaped manner along at least one longitudinal edge of the media web, said sealant forming the respective sealing region when cured.

In this way, in a manner that is cost-effective and simple in production terms, a filter element can be obtained with which an unfiltered medium side is reliably sealed off from a filtrate side of the filter element. The method allows the construction of a filter element without the usual end caps and without the use of adhesive bonds to connect the end caps to the fluid-permeable media web, forming a filter element as a whole. A filter element for example produced according to this method has, in the known manner, a fluid-permeable supporting tube which is surrounded by a pleated media web of the filter medium, the filter element being characterised in that the media web has, on at least one of its end regions, a strip-shaped sealing agent which is also folded into the media web and which is firmly connected to the media web. Folding a strip-shaped sealant into the media web can eliminate the need for adhesive bonds as a known sealant.

A filter device according to some embodiments is used for receiving such a filter element, the device being provided with a filter head which has an inlet for unfiltered medium and an outlet for filtrate, it being possible to remove, in particular unscrew, an associated filter bowl with the filter element from the filter head, which is fixed in a stationary manner by means of a pipe system. Since the filter element is releasably or firmly connected to the outlet in the filter head by means of a locator fitting of its supporting tube, the filter element can be removed from the device together with its supporting tube in an easily replaceable manner or, with the supporting tube remaining on the filter head, only the filter medium to be replaced is removed with its respective sealants, which are attached without adhesive. The latter solution in particular can be implemented in a particularly environmentally friendly manner.

Further embodiments of the method, the filter element, and the associated filter device are the subject matter of the dependent claims.

The solution according to the teachings herein is explained in greater detail below with reference to the FIGS. Specific references to components, process steps, and other elements are not intended to be limiting. Further, it is understood that like parts bear the same or similar reference numerals when referring to alternate FIGS.

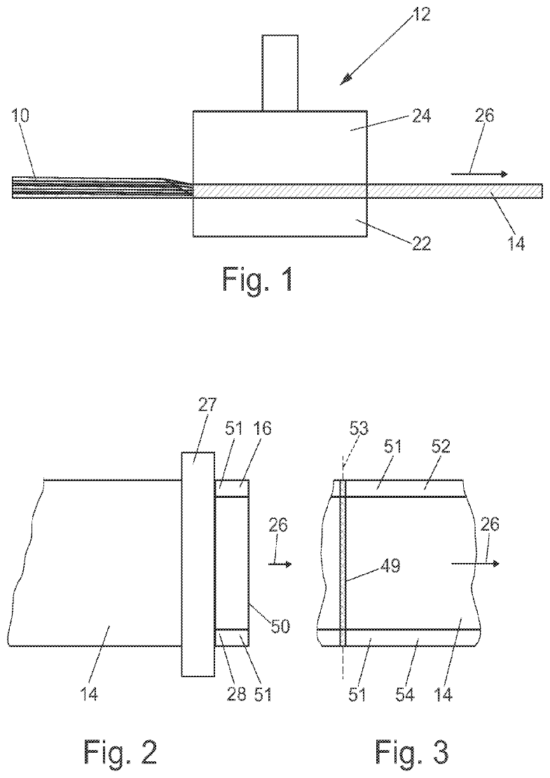

Viewed in the direction of FIG. 1, individual superimposed media layers 10 are fed on the left-hand side to a welding device referred to in its entirety as 12. The multi-layer construction of such a filter mat or media web 14 for a filter medium 15 (see FIG. 10) of a filter element 17 may, for example, have the following layer structure from one side to the other:
1. Metal wire cloth or synthetic fabric or plastic mesh with net structure,
2. Polyester nonwoven,
3. Fiberglass mat or meltblown nonwoven,
4. Fiberglass mat or meltblown nonwoven, paper nonwoven or polyester nonwoven,
5. Stainless steel polyester blended fabric or a plastic blended fabric, and
6. Metal wire cloth or synthetic fabric or plastic mesh with net structure.

Other combinations of layers are readily possible here and the layer structure is determined by the requirements that will later be placed on a finished filter element for cleaning off particulate contamination; in particular, more or fewer layers can be provided while omitting inner and outer supporting fabrics.

The welding device 12 is configured as an ultrasonic welding device with an anvil 22 and a sonotrode 24 which can be moved up and down. Embodiments are conceivable in which the sonotrode 24 is arranged such that it is stationary and the anvil 22 moves vertically up and down when viewed in the direction of FIG. 1. The specifiable direction for moving fluid-permeable media web 14 is shown by an arrow 26 in FIG. 1 to 3.

When the media web 14 leaves the welding device 12 according to FIG. 1, it is fed to a spray bar 27, arranged in a stationary manner, which sprays an application medium onto the media web 14 in a strip-shaped manner along two opposite longitudinal edges 51, the media web 14 being passed underneath the spray bar 27 in the direction of the arrow 26 by transport means that are not shown in any further detail. However, the spray bar 27 can also be moved. The application medium applied in this manner is then cured, potentially using a heat source that is not shown in any further detail, such as UV light, for example. Full curing is also not necessary; partial curing or the start of curing may instead suffice for the subsequent folding or pleating operation. As such, in any event the application medium applied in a strip-shaped manner forms a kind of sealing bead on each of the two opposite web sides of the media web 14.

Instead of spray application, the application medium can also be applied to the media web 14 as part of a 3D printing process. In any event, the respective strip forms the sealing region 52, 54 for the filter medium 15 after curing the sealant 16, 28.

In a subsequent step as shown in FIG. 3, a transverse weld 49 can be applied to the shown upper face of the media web 14 transverse to the longitudinal orientation thereof, said weld forming a smooth lateral edge 50, severed in the center along a transverse separating line 53 as shown in FIG. 2. In particular, the transverse weld 49 before severing allows the fiber material of the individual media layers 10 to be welded in before separating along the separating line 53 and thus there is no unintentional threading with fiber discharge which could otherwise also reach the filtrate side of the filter element 17 as particle contamination in the fluid flow.

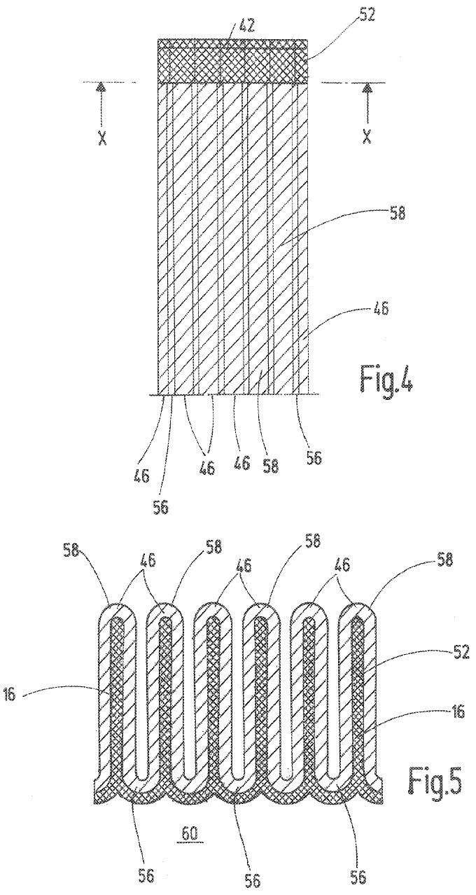

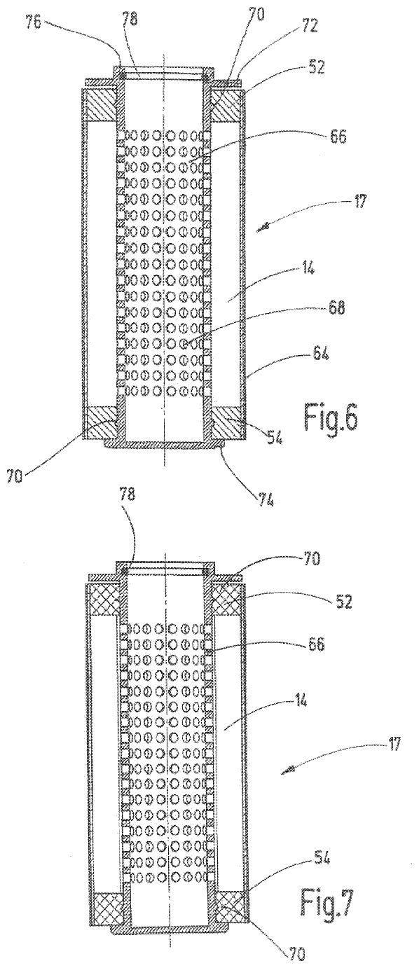

By severing the media web along the respective separating line 53, media webs 14 of a specifiable length are thus obtained, said webs being fed in the direction of the arrow 26 in the further transport direction of a pleating system (not shown), as disclosed in WO 2011/060949 A2, by way of example. WO 2011/060949 A2 is incorporated by reference herein. As such, individual filter pleats 46 are produced in a further production step as shown in FIG. 5. The media web 14 pleated in this manner is then positioned with respect to the cylindrical hollow body, as is shown in FIG. 10 for example, the two adjacent lateral edges 50 being joined together, for example by using a weld or clip seam.

As is shown in particular on FIG. 4, a sealing region 52 is obtained at least on one end side of the media web 14, wherein, according to FIG. 10, not only is there a sealing region 52 present on one side of the media web 14, but rather there is for example also a further sealing region 54 on the opposite side of the mat or media web 14, said region being configured identically to the sealing region 52. The application medium sprayed onto each edge by means of the spray bar 27 is in this case formed by an elastomer. A polyurethane foam may in this case be used as a relevant elastomer material, the resulting foam being for example formed with closed cells for an improved sealing effect. Accordingly, a rigid foam or semi-rigid foams are used instead of open-cell soft foam. Depending on the application, the spray application may also involve multiple layers using different elastomer materials.

Furthermore, thermoplastic polyurethanes and thermoplastic elastomers can also be used as application medium, including silicone. If suitable, the elastomers can also be applied in the 3D printing process.

As can also be seen in FIG. 5, the individual filter pleats 46 extend with an identical pleat height between a pleat trough 56 and a pleat crest 58. Each individual filter pleat 46 forms a gap between an ascending and a descending pleat side, the gap being completely filled by the applied and accordingly folded-in sealant 16, 28. The accordingly strip-shaped sealant 16, 28 is moreover guided along the arched path of the pleat trough on the inner side 60 of the relevant pleat troughs 56. As already explained, with regard to the spray-on operation, the respective sealant 16, 28 is joined firmly to the pleat path of the filter pleats 46, forming a kind of sealing bead.

The hollow cylindrical filter medium 15 thus produced, which has the two sealing regions 52 and 54 on the end face, is shown in FIG. 10. The media web 14 of the filter medium 15 is enclosed on the outer circumference by a film-like, fluid-permeable surrounding casing 64. Such a surrounding casing is disclosed by way of example in DE 10 2010 011 722 A1, incorporated by reference herein, it being possible for the film forming the outer sleeve as the surrounding casing 64 to consist of a polyamide or polyethylene compound. Other film materials are polyester or epoxy polyurethane. Overall, the surrounding casing 64 can be formed of a similar plastics material as mentioned above with good hot-melt characteristics and the web-like film can be joined along its opposite lateral edges, thereby forming the hollow cylindrical surrounding casing 64, by an ultrasonic welding process or by means of a welding laser. The film is appropriately perforated for passage of a fluid and the hollow cylindrical surrounding casing 64 can be slid onto the hollow body-like media web 14 from the outside as a self-contained component. Since the filter pleats 46 are correspondingly pliable, an appropriate slide-on operation is readily possible and the filter pleats 46 are held in their position by the surrounding casing 64, which improves the sealing effect to the edges of the pleated media web 14.

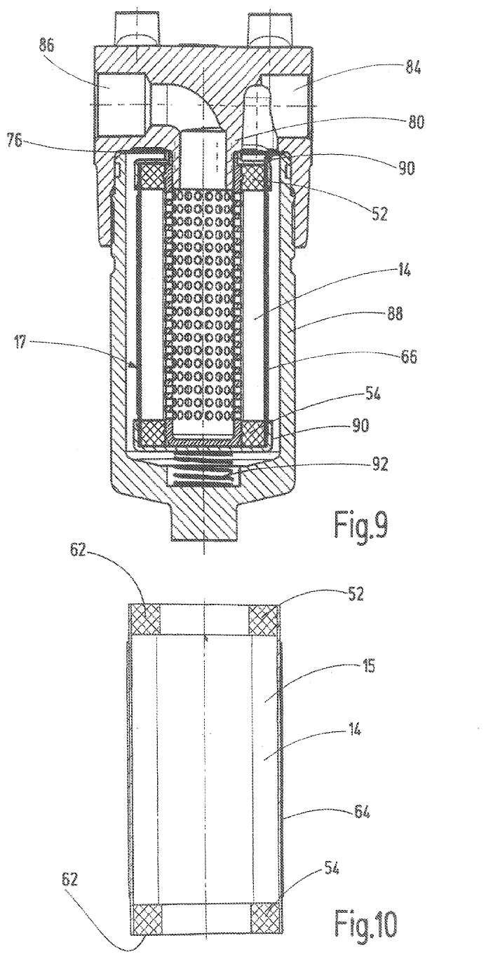

Another production option is to lay the film-like surrounding casing 64 around the media web 14 and then to weld the overlapping lateral edge regions of the film together for the purpose of obtaining the resulting closed surrounding casing 64. As FIGS. 9, 10, 13 and 15 show, the surrounding casing 64 can leave the two regions 52, 54 free; however, according to FIGS. 6 to 8 and 12, 14, 16 and 17, it is also possible to extend the surrounding casing 64, viewed in the axial direction, in such a manner that the sealing regions 52, 54 are still enclosed on the outer circumference so that the folded-in sealant 16, 28 can thus also be supported on the outer circumference on the relevant parts of the surrounding casing 64. In an embodiment according to the diagram in FIG. 11, the surrounding casing 64, viewed in the direction of FIG. 11, only encloses the upper sealing region 52 while leaving the lower sealing region 54 free.

In all the production methods described above, the filter medium 15 is thus produced without adhesives, which allows particularly cost-effective implementation, particularly if no additional end caps are required and, by avoiding adhesive bonds, the filter medium 15 is implemented in an environmentally friendly manner, particularly with regard to disposal. The filter medium 15 can now be further developed to form the complete filter element 17, as shown by way of example in FIG. 6. In this respect, the filter element 17 has, on its inner circumference, a hollow cylindrical supporting tube 66 which is provided in the region of the media web 14 with a plurality of fluid passages in the manner of a perforation 68. In this case, the pleated media web 14 rests with its individual pleat troughs 56 on the outer circumference of the hollow cylindrical supporting tube 66.

In the region of the two sealing regions 52, 54, the supporting tube 66 is provided with a closed perimeter wall along which, in a central arrangement, an annular sealing bead 70 protrudes, which in each case is an integral component of the supporting tube 66 and which engages with a specifiable pretension in the respective sealing region 52, 54 in order to increase the effect of the sealing force for the respective sealing region 52, 54. Viewed in cross-section, the respective sealing bead 70 is bowl-shaped, in particular hemispherical, with a radius between 0.3 mm and 1.0 mm, for example with a radius between 0.5 mm and 0.9 mm, for example with a radius of 0.8 mm. The sealing bead 17 compresses the pleat backs and consequently the pleat troughs 56 in such a manner that a circumferentially flat region is formed on the filter mat or the media web 14, said region resting completely on the sealing bead 70 and sealing the media web 14 with respect to the supporting tube 66 with its closed perimeter wall in this region. Good sealing results have also been achieved when the sealing bead has a triangular shape when viewed in cross-section, as shown by way of example in FIG. 7. The embodiment according to FIG. 7 differs in this respect from the otherwise identically configured embodiment of a filter element 17 according to FIG. 6.

As is also shown in FIGS. 6 and 7, the supporting tube 66 has a ring-like broadening 72, 74 on its two opposite ends which at least partially overlaps the adjacently arranged sealant 16 and 28 in each case. Viewed in the direction of FIGS. 6 and 7, in this case the upper, ring-like broadening 72 has a larger diameter than the lower broadening 74. In addition, the further lower sealing region 54 rests on the ring-like broadening 74, whereas there is an axial gap between the upper side of the sealing region 52 and the lower side of the ring-like broadening 72 which, on the one hand, illustrates that the respective broadening 72, 74 is not only required for sealing the filter medium 15, and allows a certain length adjustment between the geometry of the supporting tube 66 and the hollow body-like filter medium 15 as tolerance compensation. Since, in the embodiment according to FIGS. 6 and 7, the supporting tube 66 is configured as a one-piece, closed body, the media web 14 is to be placed around the outer circumference of the supporting tube 66 with subsequent joining of the lateral edges 50 facing each other, for example by means of an ultrasonic welding process. Subsequently, the surrounding casing 64 can be slid onto the pleated media web 14 from the outside, as previously described, or it can likewise be placed around the hollow cylindrical media web 14 as a web portion and welded along the free lateral or longitudinal edges to form a hollow tube.

Furthermore, the supporting tube 66 has at its upper free end a tubular locator fitting 76 protruding beyond the upper broadening 72 which forms an annular receiving groove on the inner circumference for receiving a locator ring 78 in the manner of an O-ring made of elastomer material.

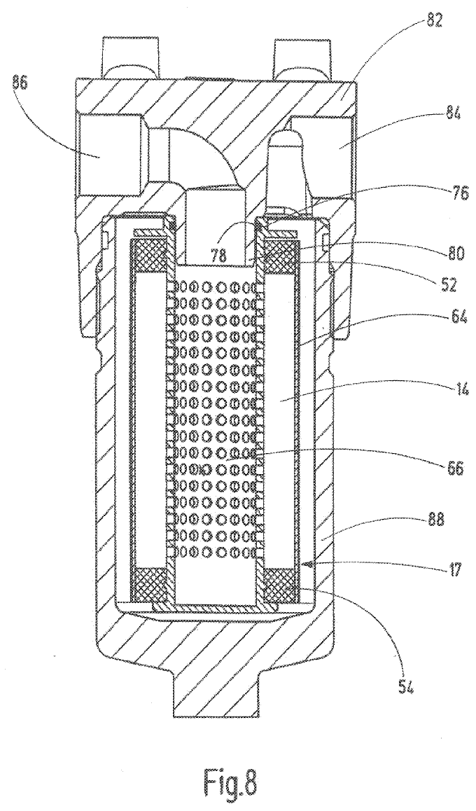

As shown in particular in FIG. 8, the filter element 17 according to FIG. 6 can be slid with its locator fitting 76 by means of the locator ring 78 onto a corresponding connection fitting 80, which is part of a filter head 82 that is arranged in a stationary manner on a pipe system which is not shown in greater detail. In this respect, the filter head 82 has an inlet 84 for unfiltered medium and an outlet 86 for filtrate. The filter element 17 is thus slid onto the connection fitting 80 of the filter head 82 as a filtrate outlet and a seal is created between the unfiltered medium side and the filtrate side of the filter device by means of the locator ring 78. A filter bowl 88 is screwed onto the filter head 82 from below, the replaceable filter element 17 being received in its entirety in said filter bowl. Filter element 17 and filter bowl 88 can be fixed to the filter head 82 in succession; however, if the design is appropriate, it is also possible to attach the filter bowl 88 to the filter head 82 together with the filter element 17. The flow of unfiltered medium coming from the inlet 84 flows through the filter element 17 from the outside to the inside in the device housing and any particle contamination remains in the filter material of the media web 14.

In the device solution according to FIG. 9, the solution is modified with respect to FIG. 8 in that the locator fitting 76 is now pressed onto the connection fitting 80 of the filter head 82 from the outside with an additional elastomer locator ring 78 and is thus firmly connected to the connection fitting 80. In addition, the filter element 17 has two end caps 90 which, between them, receive the pleated media web 14 with the two sealing regions 52, 54. The upper end cap 90 is pressed onto the free end of the locator fitting 76 and thus also onto the supporting tube 66, and the lower end cap 90 rests on a compression spring 92, which, in the operating position shown in FIG. 9, in turn rests with its lower end on a housing base of the filter bowl 88.

By means of the compression spring 92, the filter mat or media web 14 is clamped by the two end caps 90 and the media web ends with the two sealant or sealing regions 52, 54 are thus compressed by the caps 90 and pressed against the respective annular sealing bead 70 on the supporting tube 66. The solution according to FIG. 9 implements a so-called coreless variant in which the outer sleeve in the form of the surrounding casing 64 terminates axially in front of the sealing regions 52, 54 at the end of the filter mat or media web 14. Although this thus means that no locator ring 78 is used in the solution according to FIG. 9, the design shown produces a secure seal between the unfiltered medium region and the filtrate region within the filter device.

Since, in the solution according to FIG. 9, the supporting tube 66 with the upper end cap 90 is a fixed part of the filter head 82, for a replacement operation the element, in the form of the filter medium 15, is slid over the supporting tube 66 from below until the upper end, in the form of the sealing region 52, rests on the underside of the upper end cap 90 of the supporting tube 66 and is radially pretensioned by this end cap 90. Then the lower end cap 90 is slid onto the filter medium 15 with the lower sealing region 54 until the lower end cap 90 comes into contact with the supporting tube 66 which is closed at the bottom. Here, the lower end of the element, in the form of the sealing region 54, is radially pretensioned by the lower end cap 90. Finally, the filter bowl 88 as a part of the filter housing with the compression spring 92 is screwed into the filter head 82 and the compression spring 92 prevents the lower end cap 90 from slipping down unintentionally and the element composite described from becoming detached.

In the embodiment according to FIG. 11, a one-piece supporting tube 66 is used and the lower end cap 90 is thus now a component of said supporting tube 66. The filter medium 15 with the two sealing regions 52, 54, viewed in the direction of FIG. 11, is clamped at the top by means of the sleeve in the form of the surrounding casing 64 and at the bottom with the cap 90 as a one-piece component of the supporting tube 66. At the same time, the lower end cap 90 with its cylindrical surrounding rim 93, with rim-side protrusion, encloses the lower sealing region 54 of the media web 14 towards the top. The surrounding casing 64 starts adjacent thereto, enclosing the upper sealing region 52, terminating in a mutually extending horizontal plane beyond which the ring-like locator fitting 76 protrudes. The solution according to FIG. 11 thus creates an adhesive-free, functional filter element 17.

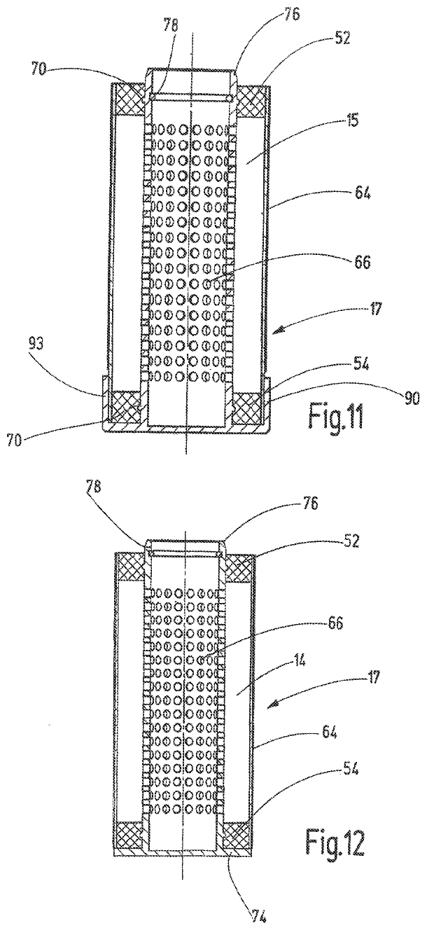

In the embodiment according to FIG. 12, the supporting tube 66 has the ring-like broadening 74 on the base side, said broadening now extending in the radial direction over the entire underside of the lower sealing region 54, replacing the lower end cap 90. The pleated media web 14 is then clamped with the sealing region in the corresponding embodiment. The film-like, perforated surrounding casing 66 thus extends over both edge sealing regions 52, 54 while leaving the outer circumferential rim of the lower broadening 74 to come into contact with the media web 14 on the outer circumferential side. In addition, unlike the embodiment according to FIG. 11, the locator ring 78 is not arranged at the level of the upper sealing bead 70 but is located rather in the horizontal plane of the free end of the upper sealing region 52 with the upper face end of the surrounding casing 64.

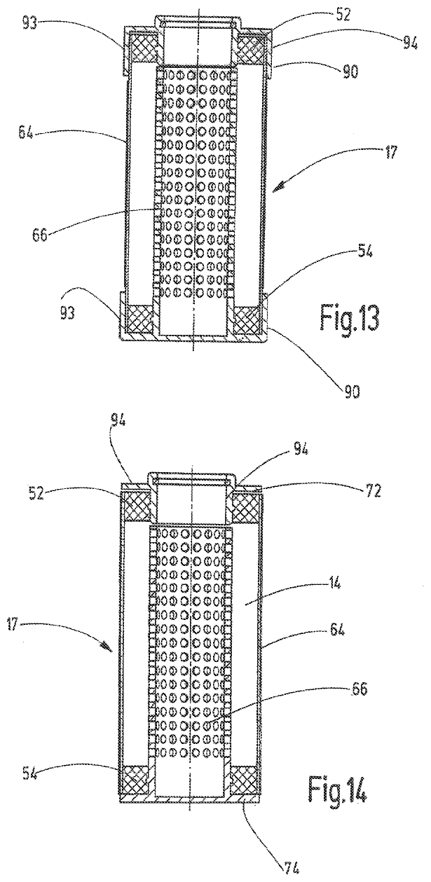

In the embodiments according to FIGS. 13 and 14, the supporting tube 66 is divided in its upper end region and now has a separate cap portion 94. The media web 14 with its respective sealing region 52, 54 is thereby clamped between the upper end cap 90 of the cap portion 94 and the lower end cap 90, in which case, for example, once again, a compression spring 92 within a housing device, comparable to the solution according to FIG. 9, is able to take over application of the contact pressure for the cap composite. Otherwise, the upper end cap 90 as well as the lower end cap 90 is configured comparably to the solution according to FIG. 11.

The upper cap portion 94 thus comprises the upper end cap 90 which circumferentially encloses the upper sealing region 52 with a cylindrical surrounding rim 93. In addition, the cap portion 94 comprises the already introduced locator fitting 76 with the locator ring 78 arranged on the inner circumference thereof. Furthermore, the associated sealing bead 70, as part of the cap portion 94, presses the upper sealing region 52 against the flank-like, downwardly protruding circumferential rim 93, of the upper end cap 90 thus formed. In the embodiment according to FIG. 13, moreover, the lower end cap 90 is configured comparably to the upper end cap 90 and protrudes with a specifiable axial protrusion beyond the end side of the sealing region 54. In this case, the surrounding casing 64 extends in a media web portion between the two opposite end caps 90.

In the embodiment according to FIG. 14, the upper cap portion 94 has the ring-like broadening 72 and likewise the supporting tube 66 is provided on its lower end with the ring-like broadening 74, comparable to the solution according to FIG. 12.

In the embodiments according to FIG. 11 to 14, the media web 14 in particular with its two sealing regions 52, 54 can be installed on the supporting tube 66 by sliding on and then an upper end cap 90 or the cap portion 94 can be attached subsequently, also by sliding on.

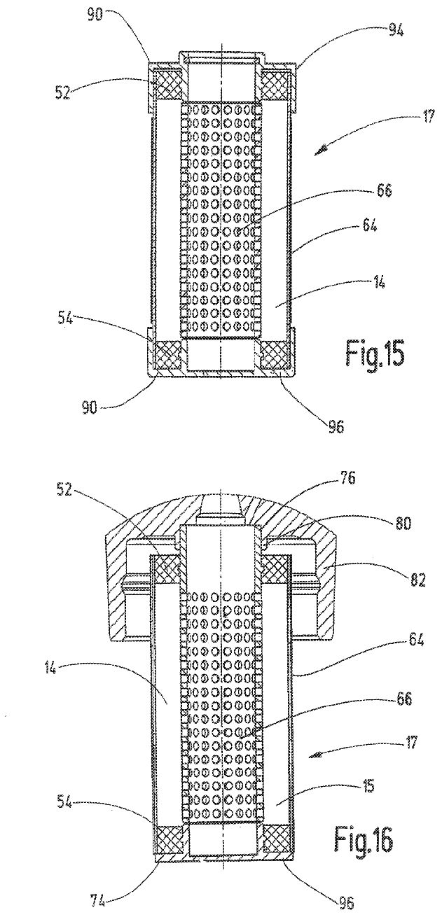

In the embodiment shown in FIG. 15 a separate lower cap portion 96 is now also provided, comparable to the configuration with the upper cap portion 94. This increases modularity for the construction of a filter element 17 by being able to freely assemble largely individual portions thereof. In this way, for example, a supporting tube 66 of different overall axial length can easily be connected to media webs 14 of comparable length and the cap portions 94, 96 can be used subsequently to complement the overall filter element 17. In the embodiments according to FIG. 11 to 15, the locator fitting 76 with integrated locator ring 78 is again used, comparable to the diagram according to FIG. 8, to slide the respective filter element 17 onto the connection fitting 80 of the filter head 82 for a fixing operation in a separable manner when replacing the element with a new element 17.

In the partially shown housing embodiment according to FIG. 16, a filter element 17 with a tubular locator fitting 76 is pressed into the inside of the connection fitting 80 of the filter head 82 so that the supporting tube 66 remains stationary on the filter head 82. A lower cap portion 96, which is configured separately from the remainder of the supporting tube 66, can then be withdrawn from the remaining supporting tube 66 for a replacement operation together with the surrounding casing 64, the pleated media web 14 and the two sealing regions 52, 54. For this purpose, the surrounding casing 64 encompasses the upper sealing region 52 and the lower sealing region 54 both with its overall axial length and on the outer circumference. The elasticity for the sealing regions 52, 54 is selected in such a manner that it is possible to withdraw the filter medium 15 in its entirety despite the respective sealing bead 70. If the filter medium 15 is soiled due to increasing particle contamination, the resulting spent medium can be replaced with a new medium 15 and the new element is slid in until the upper annular rim of the lower ring cap portion 96 comes into contact with the lower free end face of the supporting tube 66.

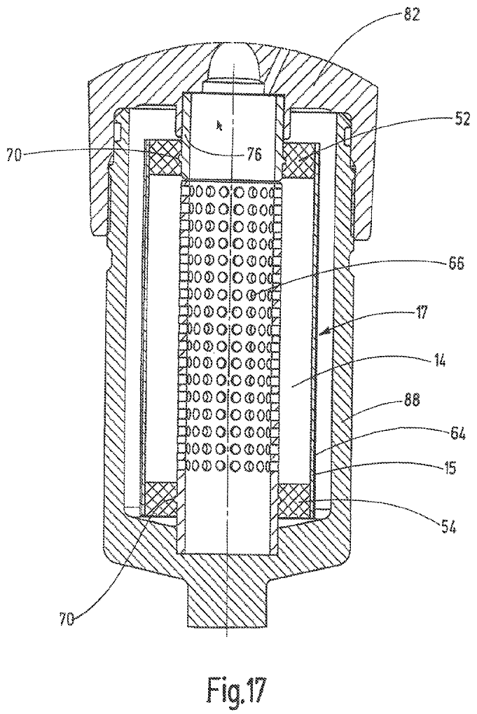

In the embodiment according to FIG. 17, in a particularly simple configuration of a coreless adapter, neither a cap portion 94 nor a cap portion 96 nor any other end cap 90 and also no ring-like broadening 72, 74 of any kind is necessary, but rather a solution comparable to the configuration according to FIG. 10 is sufficient in this case; however, with the proviso that here again the surrounding casing 64 also encloses both sealing regions 52, 54. The surrounding casing 64 thus rests with the lower sealing region 54 on the inside of the filter bowl 88. Furthermore, the supporting tube 66 can be removed from the upper locator fitting 76 remaining in the filter head 82 by withdrawing it. Increased modularity in the sense of a modular system is thus created for the comparable solution according to FIG. 17. In this case too, the media web 14 is clamped by the sleeve in the form of the surrounding casing 64. If the lower end of the supporting tube 66 is pressed into the base of the housing bowl or filter bowl 88 to a greater extent compared to the upper locating position in the filter head 82 by means of the locator fitting 76, the entire filter element 17 can thus also be withdrawn from the filter head 82 and removed in this manner when replacing the element with a new element 17. Further embodiments of an element structure to this effect are possible.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-17. (canceled)

18. A method for forming a filter medium, which is suitable for filtering fluids, for a filter element, said method comprising:
applying at least one self-contained sealant onto a fluid-permeable media web in a direction;
producing a permanent bond at least between parts of the sealant and the media web;
pleating the composite, thereby forming individual filter pleats;
producing a hollow body by joining together the two lateral edges of the media web, which are adjoining each other, opposing each other and extending transverse to the direction; wherein
the respective sealant is arranged on the inside of the hollow body, a seal is produced for each filter pleat, and an end-face seal of the media web is produced; and wherein an application medium being applied as the sealant onto the media web in a strip-shaped manner along at least one longitudinal edge of the media web, said sealant forming the respective sealing region when cured.

19. The method of claim 18, wherein the application medium is applied by a spray method or by 3D printing.

20. The method of claim 18, wherein an elastomer is used as the application medium.

21. The method of claim 20, wherein one or more of the following are used as the elastomer:
polyurethane foam,
thermoplastic polyurethane,
thermoplastic elastomer, and
silicone.

22. The method of claim 18, wherein a heat source is used to cure the application medium.

23. The method of claim 18, wherein the pleated media web is divided into web portions transverse to the direction in specifiable lengths before the hollow body is produced.

24. The method of claim 18, wherein an ultrasonic welding process is performed as the welding process.

25. The method of claim 18, wherein the respective sealant is arranged along two end faces, which are opposite to one another, in the associated end regions of the hollow body-like media web.

26. The method of claim 18, wherein the filter medium is produced without adhesive, and wherein filter pleats are outwardly enclosed by a film-like, fluid-permeable surrounding casing.

27. A filter element having a filter medium with a fluid-permeable supporting tube, which is surrounded by a pleated media web of a filter medium, wherein the media web has, on at least one of its end regions, a strip-shaped sealant which is also folded into the media web and which, as a self-contained component, is at least in part firmly connected to the media web.

28. The filter element of claim 27, wherein the supporting tube has at least one outwardly protruding sealing bead which engages in the adjacently arranged sealant while compacting said sealant.

29. The filter element of claim 27, wherein the supporting tube is configured to be fluid-impermeable in the region of contact with the respective sealant.

30. The filter element of claim 27, wherein the media web is enclosed by a film-like, fluid-permeable surrounding casing which extends at least between two opposite sealants.

31. The filter element of claim 27, wherein the supporting tube has a ring-like broadening at least on one of its ends which at least partially overlaps the adjacently arranged sealant in each case.

32. The filter element of claim 27, wherein the supporting tube has, on one of its free ends on a locator fitting, a locator ring on the inside thereof, or is configured in this region as a press-fit part.

33. The filter element of claim 27, wherein the media web is supported at least on one end cap, which is a self-contained or integral part of the supporting tube.

34. A filter device for receiving the filter element of claim 27, comprising a filter head which has an inlet for unfiltered medium and an outlet for filtrate, and a filter bowl releasably arranged thereon which receives the filter element, wherein the filter element is connected releasably or permanently to the outlet in the filter head using a locator fitting of its supporting tub.

35. The method of claim 19, wherein an elastomer is used as the application medium.

36. The method of claim 35, wherein one or more of the following are used as the elastomer:
polyurethane foam,
thermoplastic polyurethane,
thermoplastic elastomer, and
silicone.

37. The method of claim 35, wherein the pleated media web is divided into web portions transverse to the direction in specifiable lengths before the hollow body is produced and at least one separating cut for dividing is made along a separating line in a transverse weld of the media web.
